(19) United States
(12) Patent Application Publication
(10) Pub. No.: US 2022/0312704 A1
(43) Pub. Date: Oct. 6, 2022

(54) ENHANCED SELF-DRAINING HYDROPONIC FLOOD TABLE

(71) Applicant: Robert Anderson, Rosharon, TX (US)

(72) Inventor: Robert Anderson, Rosharon, TX (US)

(21) Appl. No.: 17/845,608

(22) Filed: Jun. 21, 2022

(51) Int. Cl. A01G 31/06; A01G 27/00

(52) U.S. Cl. CPC A01G 31/06; A01G 27/001

(57) ABSTRACT

Embodiments of the invention provides an enhanced self-draining crop growing tray/flood table where smaller growing trays can be located for automated watering systems. The self-draining crop growing tray .flood table of the present invention allows enhanced self-draining on a level table with inclined slopes. The enhanced self-draining hydroponic flood table comprises an inlet and an outlet formed. This type of table requires cleaning at frequent intervals and the growing trays inside the flood tray/growing table will all receive the same depth of water or a water solubilized nutrient solution.

### TECHNICAL FIELD

The present invention relates to a modular hydroponic hood table and an arrangement thereof and more specifically relates to a self-draining hydroponic flood table.

### BACKGROUND

In the field of horticulture plants are grown in a type of container containing soil or various nutrient or inert medium(s). The containers are placed in flood tables or trays, where the tray is flooded with water or liquid nutrients in order to expose the plant's roots to the water or liquid nutrients. The flood tables are typically a fiat shallow box or table made of wood, plastic or metal having a depth suitable to hold liquid.

In hydroponic growing operations, water is typically pumped. from a reservoir into a hydroponic flood table which holds the plants. However, the water level in the flood table must not exceed a specified height depth or flooded time duration, otherwise the plants within the flood table can be over watered and potentially drown and die. Therefore, a draining control must be in place to ensure that the water level does not reach unintended heights which may cause damage to the plants within the table. However, it is desirable to be able to alter the height. of the water level within the hydroponic flood table, to suit one's particular needs.

The inventors of the present invention have realized that none of the flood tables or trays designs available conventionally have sloped draining channels and/or capability. Most, if not all, the flood tables or tray designs have drainage pathways but no inclination\slope to the design of the pathways. As a result, there is buildup in the ends or corners that increase the plants susceptibility to plant diseases and solution buildup, thus the trays need more frequent cleaning. Flood tables or trays without the invention must be mounted on a slope to facilitate draining; this also means that plants closer to the drain end are over watered on the deep/drain end of the tray.

While the prior art discloses many types of flood tables or trays, so far as is known, none of these assemblies solve these problems in a simple, effective and highly advantageous manner, as in the present invention.

### SUMMARY OF THE INVENTION

It is therefore an object of the present invention to provide a novel and enhanced solution to enable superior draining of the tray/flood table.

Embodiments of the invention provide an enhanced self-draining crop growing tray/flood table where plowing trays can be located and flooded for automated watering systems. The self-draining crop growing tray/flood table of the present invention allows self-draining on a level table and if the tray/flood table is installed on a level surface or apparatus, all crop(s) placed in any area of the tray/flood table are to receive the same depth of water. Additionally with introduction of the sloped drainage pathways a more complete drain of the flood solution is to be achieved.

Embodiments of the invention provide a self-draining crop growing tray/flood table with inclination or slope in the drainage pathway to enable enhanced self-draining by design or utility.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates a perspective view of an enhanced self-draining crop growing tray/flood table, according to an embodiment of the present invention.

### DETAILED DESCRIPTION OF DRAWINGS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of embodiments of the present invention. It may be apparent to one skilled in the art that embodiments of the present invention may be practiced without some of these specific details.

Various terms as used herein are shown below. To the extent a term used, it should be given the broadest definition persons in the pertinent art have given that term as reflected in printed publications and issued patents at the time of filing.

The inventors of the present invention have realized that none of the flood tables or trays designs available conventionally are designed with sloped drainage pathways and/or capability. Most, if not all, the flood tables or trays designs have drainage pathways but no inclination to the pathway design itself As a result, there is buildup in the pathways and/or in the corners that accumulate sediment and ultimately increase the crops susceptibility to plant diseases and make the trays need more frequent: cleaning or need to be replaced. These flood tables or trays without the sloped drainage pathways must be mounted on a sloped surface or apparatus to facilitate draining: this also means the crop at the drain location of the tray/flood table can become over watered.

While the prior art discloses many types of flood tables or trays, so far as is known, none of these assemblies solve the problems discussed in the background. The present invention discloses the novel solution in a simple, effective and in a highly advantageous manner

Embodiments of the invention provides a self-draining crop growing tray/flood table where smaller growing containers can be located for automated or manual watering systems. The enhanced self-draining crop growing tray/flood table of the present invention allows enhanced self-draining on a level table and all growing trays/containers are to receive the same depth of water during the flood cycle(s).

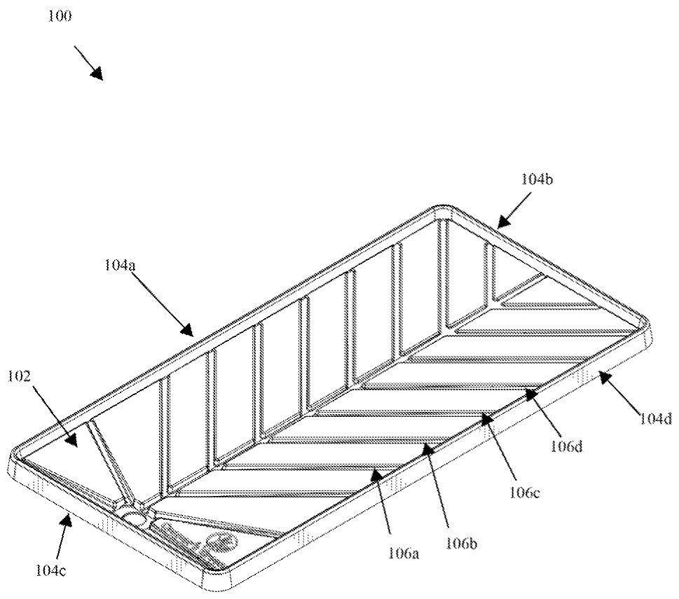

In an embodiment, an enhanced self-draining hydroponic flood table (100) illustrated in FIG. 1 for holding one or more crops (not shown) is provided. The enhanced self-draining hydroponic flood table includes a base wall 102 enclosed inside a plurality of side walls 104a, 104b, 104c, and 104d forming at least a cavity or basin (not shown) to receive liquid therein. The base wall 100 provides support to the one or more crops/containers held. therein.

The base wall 102 is configured to be flat.

The base wall 102 comprises a plurality of grooves not limited to 106a, 106b, 106c, 106d, 106e, and 106f on its inner surface creating sloped drainage pathways to allow more efficient draining of liquid solutions that are introduced to the tray/flood table, additionally these sloped drainage channels enable not only more efficient draining of the tray/flood table, but when the tray is installed on a level surface the depth of flood solution is also level and of most consistent depth inside the basin.

In an exemplary embodiment, the liquid/flood solution is received in the flood table from a reservoir.

In an exemplary embodiment, the plurality of grooves allows for enhanced self-draining of the flood table.

In an exemplary embodiment, the pre-determined drainage channel slope is established based on a height the one or more crops such that each of the one or more crops receive a same depth of liquid and a specified height of a liquid level that avoids over watering or drowning of the crop(s).

In an exemplary embodiment, the self-draining hydroponic flood table is adapted to engage as an element of a crop production system.

In an exemplary embodiment, the self-draining hydroponic flood table is slidably removed from the crop production system.

In an exemplary embodiment, the self-draining hydroponic flood table is located inside the crop production system and more easily removed for cleaning.

In an exemplary embodiment, each of the plurality of grooves on the inner surface of the self-draining hydroponic flood table comprises an inlet and an outlet formed. [0030] In an exemplary embodiment, the inlet and the outlet of each of the plurality of grooves forms flood channel on the inner surface for directing the liquid from the inlet to the outlet.

In an exemplary embodiment, the liquid is water or a liquid nutrient solution (fertilizer).

In an exemplary embodiment, each of the plurality of grooves comprises an associated pore to drain the liquid.

In an exemplary embodiment, the enhanced sell-draining hydroponic flood table is used in a crop production system.

In another embodiment, a crop production system is provided. The crop production system includes an enhanced self-draining hydroponic flood table for holding one or more crops. The flood table is a flat shallow box or a table made of wood, plastic or metals having a depth suitable to hold liquid. The flood table includes a base wall enclosed inside a plurality of side walls forming the depth to receive liquid therein, the base wall provide support to the one or more crops held therein.

The drainage channels are inclined at a pre-determined angle and the base wall is formed to include a plurality of grooves on its inner surface creating drainage pathways to allow excess liquid in the flood table to drain out when the flood cycle is finished.

In an exemplary embodiment, the liquid is received in the flood table from a reservoir or external source.

In an exemplary embodiment, the plurality of grooves achieves enhanced self-draining of the flood table.

In an exemplary embodiment, the pre-determined angle is determined based on a height the one or more crops such that each of the one or more crops receive a same depth of liquid and a specified height of a liquid level that avoids over\under watering or drowning of the one or more crops. The predetermined angle of the drainage channels is based on about ⅛ inch per foot of table (typical plumbing drain elevation).

In an exemplary embodiment, the self-draining hydroponic flood table is adapted to slidably engage with a crop production system.

In an exemplary embodiment, the self-draining hydroponic flood table is slidably removed from the crop production system for cleaning.

In an exemplary embodiment, the self-draining hydroponic flood table is fixed inside the crop production system.

In an exemplary embodiment, each of the plurality of drainage grooves or channels on the inner surface of the enhanced self-draining hydroponic flood table comprises an inlet and an outlet thrilled.

In an exemplary embodiment, the inlet and the outlet of each of the plurality of grooves forms a flood channel on the inner surface for directing the liquid from the inlet to the outlet.

In an exemplary embodiment, the drainage channels configured to act as flood channels for reversing the flow of the drain (from the reservoir) to introduces nutrient solution to the table thus creating the flood, Stopping the flood and allowing the drain hack to the reservoir is the receding flood.

A user of the invention may have a separate system for introduction of the nutrient solution and not use the drain to introduce the nutrient solution.

In an exemplary embodiment, the liquid is water or a water solubilized nutrient solution.

In an exemplary embodiment, each of the plurality of grooves comprises an associated outlet to drain the liquid.

In an exemplary embodiment, the enhanced self-draining hydroponic flood table is used in a crop production system.

In another embodiment, the invention can be implemented in vertical or sloped hydroponic farming.

Although the present invention herein has been described with reference to particular preferred embodiments thereof, it is to be understood that these embodiments are merely illustrative of the principles and applications of the invention. Therefore, modifications may be made to these embodiments and other arrangements may be devised without departing from the spirit and scope of the invention, which is defined by the appended claims.

What is claimed is:

1. An enhanced self-draining hydroponic flood table for holding one or more crops, comprising:
a base wall enclosed inside a plurality of side walls forming at least a cavity to receive liquid therein, the base wall provide support to the one or more crops held therein,
wherein the base wall is flat and the base wall comprises a plurality of grooves on its inner surface creating sloped drainage pathways to allow liquid based solutions in the flood table to drain out most efficiently.

2. The enhanced self-draining hydroponic flood table of claim 1, wherein the liquid is received in the flood table from a reservoir.

3. The self-draining hydroponic flood table of claim 1, wherein the plurality of grooves allows enhanced self-draining of the flood table.

4. The self-draining hydroponic flood table of claim 1, wherein one or more crops receive a same depth of liquid and a specified height of a liquid level during flood which achieves a consistent depth of the flood solution in the tray/flood table

5. The self-draining hydroponic flood table of claim 1, wherein the self-draining hydroponic flood table is adapted to slidably engage with a crop production system.

6. The self-draining hydroponic flood table of claim 1, wherein the self-draining hydroponic flood table is slidably removed from the crop production system.

7. The self-draining hydroponic flood table of claim 1, wherein the self-draining hydroponic flood table is fixed inside the crop production system.

8. The self-draining hydroponic flood table of claim 1, wherein each of the plurality of grooves on the inner surface of the enhanced self-draining hydroponic flood table comprises an inlet and an outlet formed.

9. The self-draining hydroponic flood table of claim 1, wherein the inlet and the outlet of each of the plurality of grooves forms a flood channel on the inner surface for directing the liquid from the inlet to the outlet.

10. The self-draining hydroponic flood table of claim 1, wherein the liquid is water or hydroponic solution, fertilizer or water solubilized nutrient solution.

11. The self-draining hydroponic flood table of claim 1, wherein each of the plurality of grooves comprises an associated outlet to drain the liquid.

12. The self-draining hydroponic flood table of claim 1 is used in a crop production system.

13. A crop production system comprising:
a self-draining hydroponic flood table for holding one or more crops in smaller trays or pots, wherein the flood table is a flat shallow box basin or a table made of wood, plastic or metal having a depth suitable to hold liquid, and wherein the flood table having,
a base wall enclosed inside a plurality of side walls forming the depth to receive liquid therein, the base wall provide support to the one or more crops held therein,
wherein the base wall is flat and the base wall comprises a plurality of grooves\drainage channels on its inner surface creating drainage pathways to allow more efficient drainage during flood cycles.

14. The crop production system of claim 13, wherein the liquid is received in the flood table from a reservoir.

15. The crop production system of claim 13, wherein the plurality of grooves allows enhanced self-draining of the flood table.

16. The crop production system of claim 13, wherein the pre-determined angle is determined based on a height the one or more crops such that each of the one or more crops receive a same depth of liquid and a specified height of a liquid level, which offers more efficient drainage during flood cycles.

17. The crop production system of claim 13, wherein the enhanced self-draining hydroponic flood table is adapted to slidably engage with a crop production system, such that the self-draining hydroponic flood table is configured to be slidably removed from the crop production system.

18. The crop production system of claim 13, wherein each of the plurality of grooves on the inner surface of the self-draining hydroponic flood table comprises an inlet and an outlet formed.

19. The crop production system of claim 13, wherein the inlet and the outlet of each of the plurality of grooves to act as either a drainage channel or a flood channel or combination of both.

20. The crop production system of claim 13, wherein each of the plurality of grooves comprises an associated outlet to drain the liquid.
